(19) United States
(12) Patent Application Publication
(10) Pub. No.: US 2003/0008260 A1
(43) Pub. Date: Jan. 9, 2003

(54) Optical curing apparatus

(76) Inventors: Wen-Hao Wang, Taipei Hsien (TW); Shu-Lung Wang, Taipei Hsien (TW)

Correspondence Address: BACON & THOMAS, PLLC, 625 SLATERS LANE, FOURTH FLOOR, ALEXANDRIA, VA, 22314

(21) Appl. No.: 09/897,079

(22) Filed: Jul. 3, 2001

(51) Int. Cl. A61C 3/00

(52) U.S. Cl. 433/29

(57) ABSTRACT

An optical curing apparatus consists of a body, a gun and control circuits located in the body and the gun to solidify dental resin filling in the decayed teeth in the shortest time so that the dental resin will be filled in the teeth firmly and repeated teeth decay may be avoided. The control circuits may control light projecting time period and adjust optical output power, and detect if optical power output is normal. When the optical output power is below a preset standard value, the apparatus will generate an alert to notify users to replace the lamp set in the curing apparatus.

### BACKGROUND OF THE INVENTION

The present invention relates to an optical curing apparatus and particularly an optical curing apparatus for solidifying dental resin filling in the decayed teeth.

In the dental treatments or checkups, when patients are found having a severe decayed tooth, the dentists might suggest to extract the decayed tooth. Whereas when the decayed tooth is not very severe and is still mendable, the dentists would generally suggest to give the decayed tooth proper medical treatments.

The medical treatments for the decayed tooth usually includes to clean the decayed cavity first. After the decayed cavity has been thoroughly cleaned, the dentist will fill the decayed cavity with a dental amalgam which includes metal powders and filling solution. After the dental amalgam is dried, the dentist will grind and smooth the filled dental amalgam to make it fit for patient's daily use such as eating and drinking. However, conventional dental amalgam is prone to loosen after using for a period of time. At the initial time when the dental amalgam is loosened, the patient usually does not aware. It is when the patient finally feels pain in decayed tooth, then the patient discovers that the dental amalgam has broken loose or chipped away. The damage is already done and the tooth is decayed for the second time.

In order to resolve this problem, there are special dental resins being developed to replace the metal-powder-based dental amalgam. Whereas, when using these types of dental resins to fill the decayed tooth, the dentists generally have to use an optical curing machine to generate optical power to solidify the resins for cementing the resins in the tooth cavity firmly. This type of treatment and filling has drawbacks. For instance, during tooth filling, the optical power generated by the optical curing machine could be not sufficient and result in not totally solidification of the dental resin. After the using for a period of time, the filled dental resin could still get loosened or broken away. As dentists generally are not experts of the optical curing machines, they could mistakenly attribute the problems to the functional deficiency of the dental resin without recognizing the deficiency of optical power of the optical curing machines. When trying to fill the decayed tooth for the patient the second time, the dentist might tempt to prolong the light projecting time to cure the resin. As a result, the patient could be over exposed to the optical power of the optical curing machine. It is not desirable.

### SUMMARY OF THE INVENTION

The primary object of the present invention is to resolve the foregoing disadvantages. The invention provides a novel curing apparatus which includes an optical power measuring function to allow the dentists measuring and checking the optical power before using so that the dental resin filled in the decayed teeth may be fully solidified.

Another object of the invention is to provide controllable light projecting time and generate audio signals at a selected interval to alert the dentists.

A further object of the invention is to offer adjustable optical power output and extended projection time.

In order to achieve the foregoing objects, the optical curing apparatus of the present invention consists of a body, a gun and control circuits located in the body and the gun. Through the invention, the dental resin filled in the teeth may be solidified at the shortest time and firmly embedded in the teeth without loosening easily. Hence the repeated tooth decay may be prevented. Moreover, the control circuits may be used to adjust light projection time and optical power output, and to check if the optical output is normal. Once the optical output is below a preset standard value, the curing apparatus will generate signals to alert users to replace the lamp set of the curing apparatus.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an optical curing apparatus of the present invention.

FIG. 2 is an exploded view of a body of the optical curing apparatus according to FIG. 1

FIG. 3 is an exploded view of a gun of the optical curing apparatus according to FIG. 1.

FIG. 4 is a fragmentary sectional view of the gun shown in FIG. 3.

FIG. 5 is a circuit block diagram of the present invention.

FIG. 6-A, 6-B and 6-C are circuit diagrams for FIG. 5.

### DESCRIPTION OF THE PREFERRED EMBODIMENT

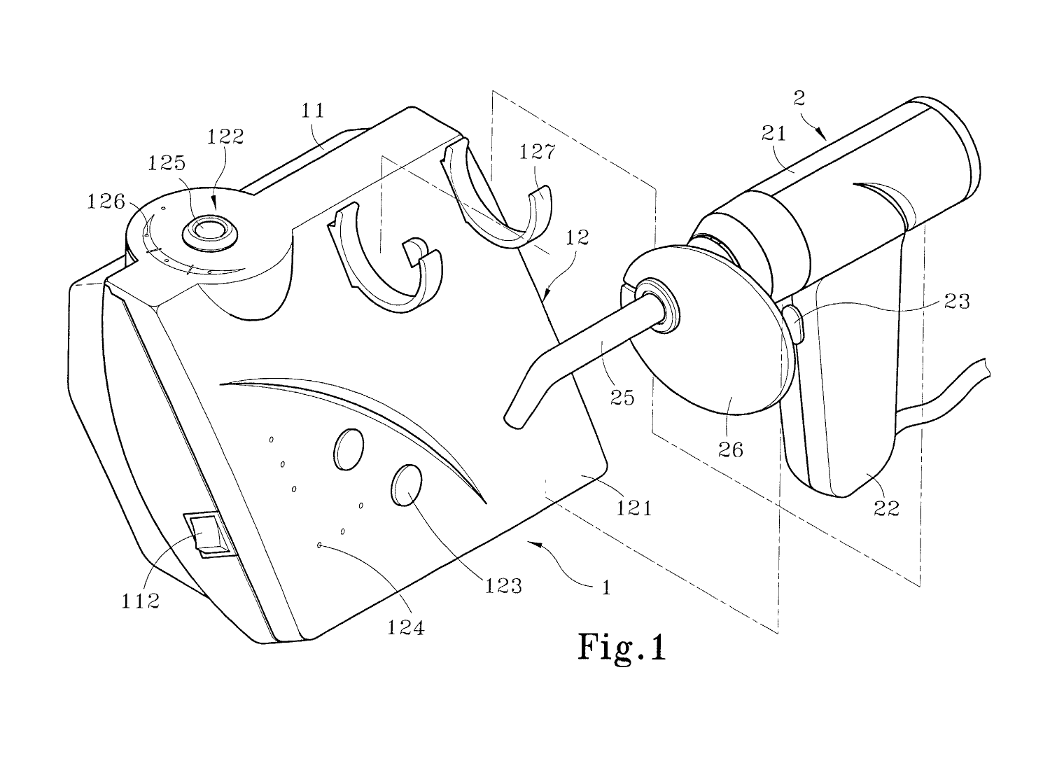

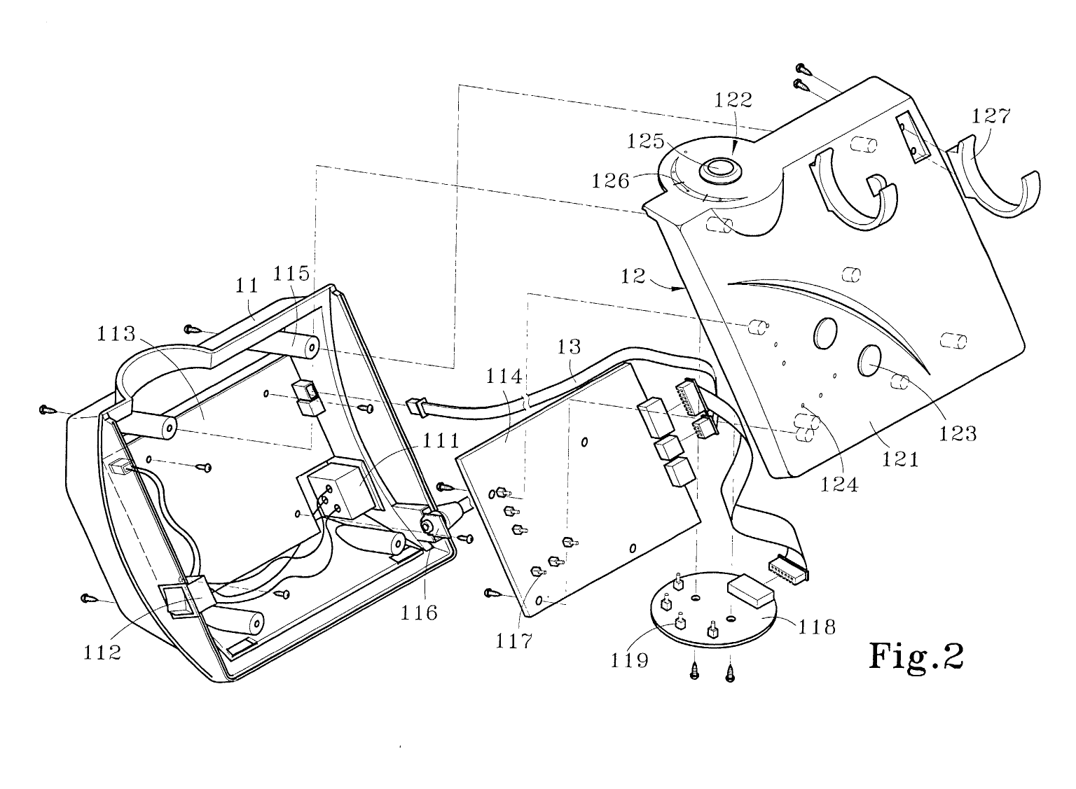

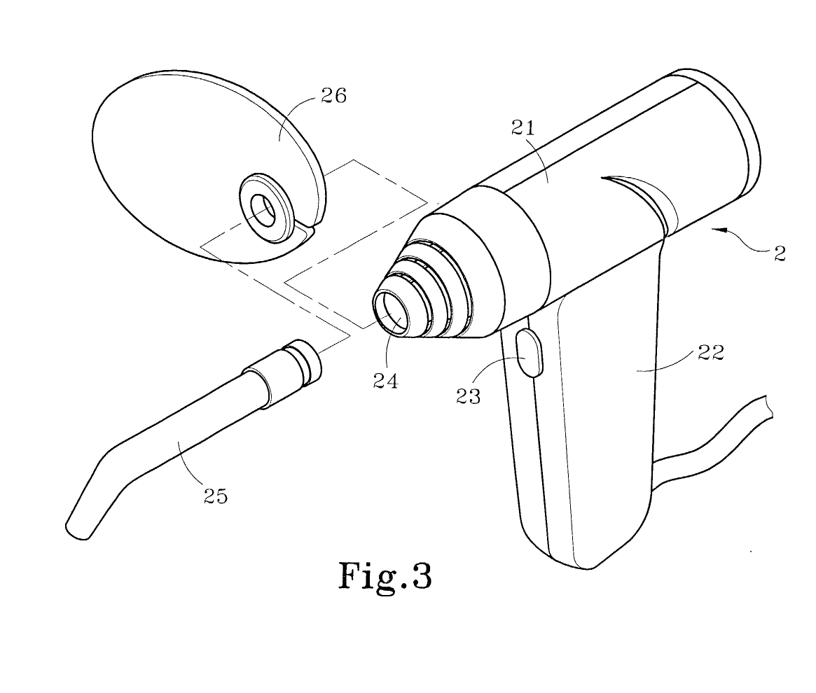

Referring to FIGS. 1, 2 and 3, the optical curing apparatus of the invention includes a structure portion and a control circuitry portion aiming to solidify the filling dental resin in the shortest possible time and to ensure that the dental resin won't get loose easily and to prevent repeated tooth decay.

The apparatus of the invention consists of a body 1 and a gun 2. The body 1 includes a base casing 11 and a face panel 12. The base casing 11 has a power supply input end 111, a power switch 112, a power circuit board 113 for converting AC electricity to DC output, and a main control circuit board 114. The base casing 11 further has protrusive struts 115 to fasten the face panel 12 and an output end 116 linking to the gun 2.

The face panel 12 includes a first face panel 121 and a second face panel 122. On the first panel 121, there are a plurality of push buttons 123 and a plurality of first apertures 124. The push buttons 123 are for activating the optical curing apparatus and adjusting output power of the apparatus. The first apertures 124 are used to house and expose light emitting elements 117 of the main control circuit board 114 for displaying and indicating the operation and power adjustment status of the apparatus. On the second face panel 122, there is a test opening 125 and a plurality of second apertures 126 formed around one side of the test opening 125. There is a test circuit board 118 located beneath the second face panel 122 that has a plurality of light emitting elements 119 wedged in and exposed through the second apertures 126. When the output end of the gun 2 projects light to the test opening 125, the test circuit board 118 will receive and display to indicate if the output light of the gun 2 has sufficient power and to notify the user if to replace the lamp set (not shown in the drawings) in the gun 2.

On one side of the first face panel 121, there is a bracket 127 for holding the gun 2 when not in use. After the elements set forth above are assembled and mounted, a plurality of conducting wires 13 will be deployed to link the power supply circuit board 113, main control circuit board 114 and test circuit board 118 to facilitate power and signal transmission among them.

The gun 2 includes a barrel 21 which has at least one lamp set (not shown in the drawings) and an air fan (also not shown in the drawings) located therein, and a handle 22 extended from the barrel 21. On the handle 22, there is a trigger button 23 for activating the lamp set. The barrel 21 has an output opening 24 which is engageable with a fiber tube 25. The fiber tube 25 is an uniform tube or a tapered tube with a narrower front end to accelerate the output light. The fiber tube 25 may further engage with a colored and transparent protection shield 26 to prevent the light projecting out from the fiber tube 25 from hurting user's eyes.

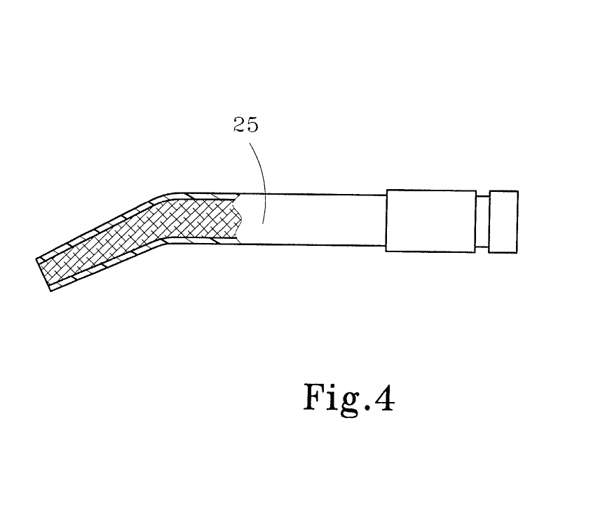

When the switch 112 is activated, the main control circuit board 114 in the body 1 will check sequentially all the internal circuits. After checking completed and accepted, a buzz sound will be generated and the apparatus is under a ready condition. When the user presses the trigger button 23 on the gun 2, the lamp set in the barrel 21 will generate light and emit out through the output opening 24 and the fiber tube 25. The emitting light will accelerate when passing through the narrow front end of the fiber tube 25 (as shown in FIG. 4). The projecting light then may be directed to the dental resin filled in the decay tooth to solidify the dental resin and to allow the solidified dental resin filled in the tooth firmly.

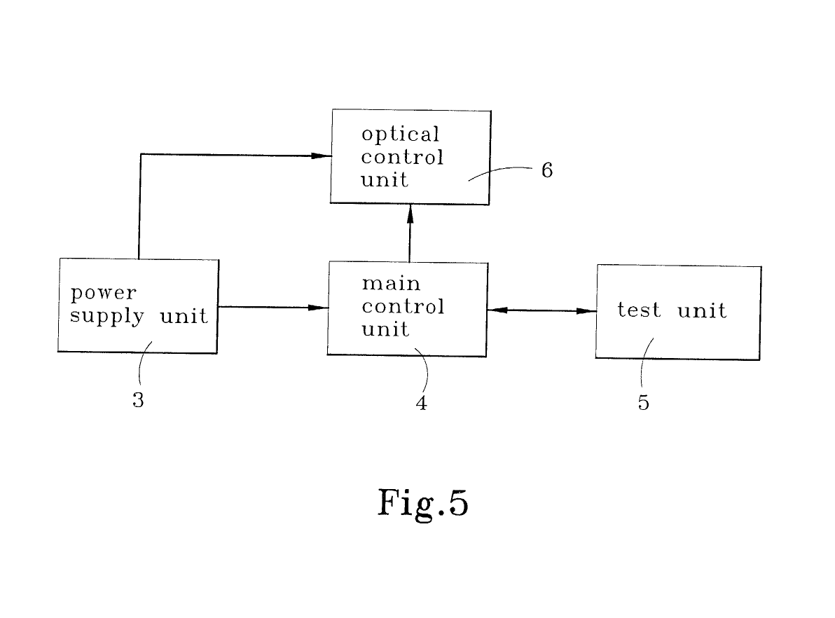

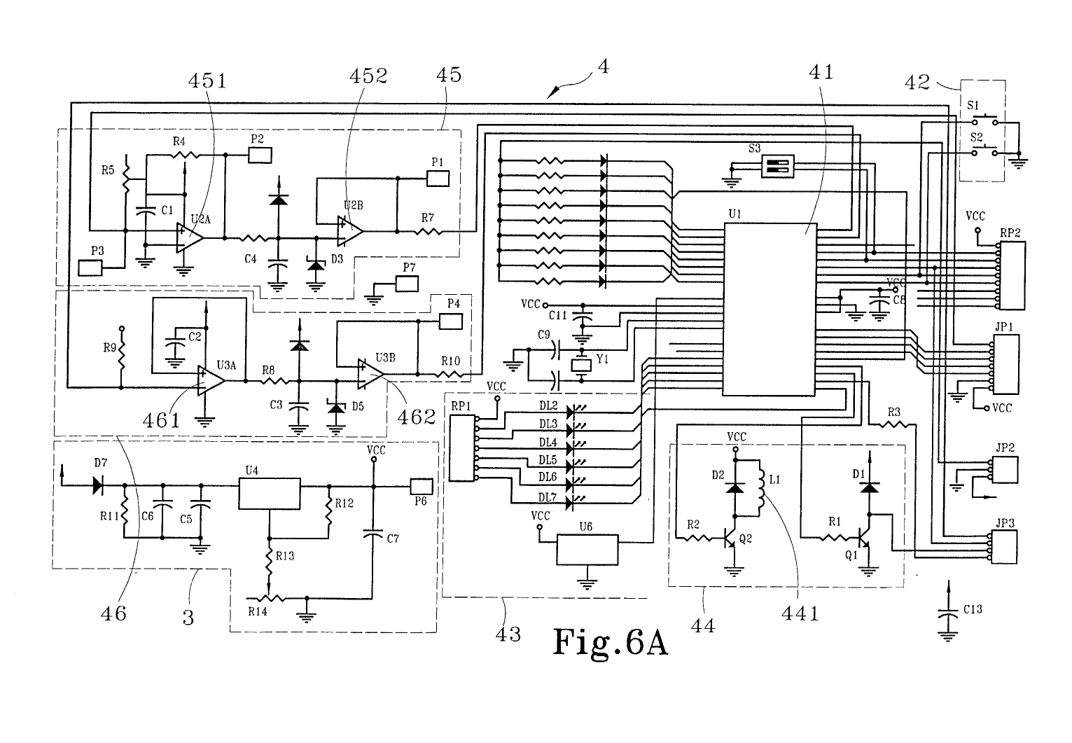

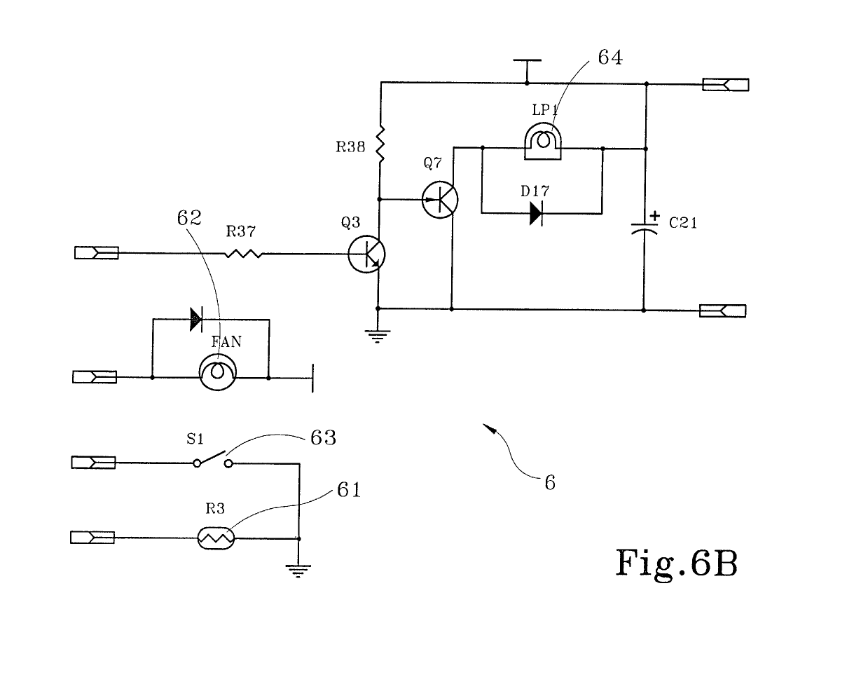

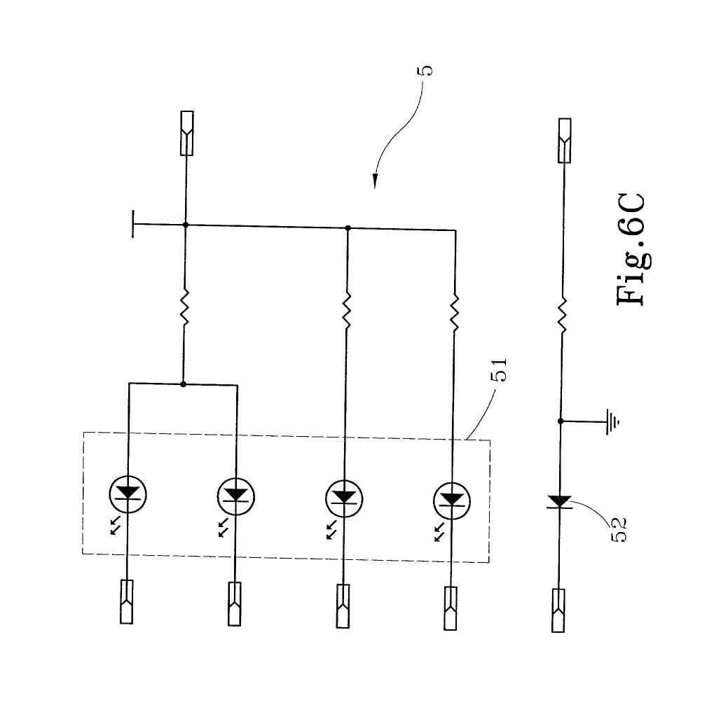

Referring to FIGS. 5, 6-A through 6-C, the control circuits of the invention includes a power supply unit 3, a main control unit 4, a test unit 5 and an optical control unit 6. The power supply unit 3 is located on the power supply circuit board 113 for receiving AC electric power and converting to a DC power output for use in various units.

The main control unit 4 is located on the main control circuit board 114 and includes a microprocessor 41, a push button set 42, a display circuit 43, a driving circuit 44, an optical test circuit 45 and a temperature test circuit 46.

The microprocessor 41 is to receive signals transmitted by various circuits and to output signals to drive various circuits.

The push button set 42 includes a plurality of push buttons to output activation signals and control signals for adjusting output power, and to transmit to the microprocessor 41 for processing.

The display circuit 43 consists of a plurality of light emitting elements to receive output signals delivered from the microprocessor 41 to indicate the activation and output power status.

The driving circuit 44 has an output element 441 which may include a buzzer or speaker. When the driving circuit 44 is activated by the microprocessor 41, the driving circuit 44 triggers the output element 441 to generate audio signals to notify the user about light projecting time control.

The optical test circuit 45 includes a voltage amplifier 451 and a filter 452 to receive a test optical signal output by the test unit 5. After the test signal is amplified through the voltage amplifier 451 and processed by the filter 452, the signal will be transmitted to the microprocessor 41 for processing, and actuate the light emitting elements 51 of the test unit 5 for displaying (as shown in FIG. 6-C) the light illumination power. Users then may determine if the lamp set 64 in the gun 2 needs replacement.

The temperature test circuit 46 includes a voltage amplifier 461 and a filter 462 to receive a temperature signal detected by a sensor element 61 located in the optical control unit 6 (as shown in FIG. 6-B). After being amplified by the voltage amplifier 461 and processed by the filter 462, the signal is transmitted to the microprocessor 41 for processing, then to activate the air fan 62 on the optical control unit 6 for dispersing heat.

The test unit 5 is located on the test circuit board 118 and includes a plurality of light emitting elements 51 and a sensor element 52. When the sensor element 52 senses light illumination and generates a signal which is processed by the optical test circuit 45 and the microprocessor 41, the test unit 5 will be driven by the microprocessor 41 and adjust light illumination of the light emitting elements 51.

The optical control unit 6 is housed in the gun 2 and substantially consists of a sensor element 61, an air fan 62, a push button 63 and a lamp set 64. When the push button 63 is pressed, the lamp set 64 will be activated immediately and generate light. After projecting the light for a period of time, and when the sensor element 61 detects the temperature generated by the lamp set 64 is too high, a signal will be output to the temperature test circuit 46 and the microprocessor 41 to activate the air fan 62 for dispersing heat.

When the switch 112 is activated, the microprocessor 41 will check sequentially all the internal circuits and display the results through the display circuit 43. After test completed, the microprocessor 41 will trigger the driving circuit 44 to generate a buzz sound to indicate that the apparatus is under the ready condition.

In the general operation, after the push button 42 is pressed, light projecting time period may be controlled as desired, for instance to 10 seconds, 20 seconds, and 30 seconds. When setting to 10 seconds, a buzz sound will be generated for every 5 seconds. After 10 seconds and buzz once, light projecting will be stopped. When setting for 20 seconds, the buzz sound will be generated for every 10 seconds, and after 20 seconds and buzz once again, light projection will be stopped. For setting 30 seconds, a buzz sound will be generated every 10 seconds, and two buzz sound will be generated at the 20th second, and at the 30th second, another buzz will be generated and stop the light projection.

The invention may be set for staged operation, for instance with a lower power at the front stage for 10 seconds and a higher power at the rear stage for 30 seconds. Light illumination for 10 seconds is about 200 MW/C m² (displayed through the display circuit 43). Light illumination for 30 seconds is about 600 MW/C m² (displayed through the display circuit 43). When performing the first stage operation, a buzz sound will be generated every 5 seconds. After 10 seconds, the second stage operation of 30 seconds will be executed. When there is a desire to shorten the execution time of the first stage, pressing the push button 63 once after 5 seconds, then the power may be increased instantaneously to about 600 MW/C m² (the time for front stage may be less than 10 seconds). The execution time for the second stage is 30 seconds. After the operation is completed, the display circuit 43 will indicate the apparatus is under the ready condition.

On light measurement, pointing the fiber tube 25 of the gun 2 to the test opening 125 to project light to the test unit 5 which will receive the light and transmit to the optical test circuit 45 and microprocessor 41 for processing. After processing, the light emitting elements 51 on the test unit 5 will indicate the outcome. When light indication shows that light projecting power is above 600 MW/C m², it is a GOOD condition. When light indication shows that light projecting power is between 200 and 600 MW/C m², it is an EXTENDED TIME condition. When light indication shows that light projecting power is below 200 MW/C m², it is a REPLACE LAMP condition. An AUTO ADJUST light display will be shown for automatic extension of light projecting time.

When the display shows that light projecting power is above 600 MW/C m², and is a GOOD condition, the display will be stopped after the test.

When the display shows that light projecting power is between 200 and 600 MW/C m², and is an EXTENDED TIME (extend execution time), extension time of 3 seconds and 6 seconds may be set. When light projecting power is between 200 and 400 MW/C m², the extension time is 6 seconds. When light projecting power is between 400 and 600 MW/C m², the extension time is 3 seconds.

When light projecting power is below 200 MW/C m² and is a REPLACE LAMP condition, a continuous buzz sound will be generated to alert the user that the lamp set 64 requires replacement.

Furthermore, when the power supply switch is turned off or reactivated, all the set function will be erased so that users may reset or adjust the optical power.

What is claimed is:

1. An optical curing apparatus for solidifying dental resin filling in a tooth to allow the dental resin filled in the tooth firmly without loosening off for preventing the tooth from repeatedly decaying, comprising:
a body including a base casing and a face panel, the base casing having a power supply circuit board and a main control board located thereon, the face panel having a first face panel and a second face panel, the first face panel having a plurality of push buttons and a plurality of first apertures for displaying activation status of the curing apparatus and adjusting power conditions, the second face panel having a test opening and a plurality of second apertures and a test circuit board located therebeneath for testing and displaying optical power;
a gun having a barrel, a handle extended from the barrel -having a trigger button located thereon, an output opening located at a front end thereof and a fiber tube engageable with the output opening;
wherein the gun generates light under the control of the circuits in the body to project the dental resin in the filling tooth to solidify the resin firmly without loosening away.

2. The optical curing apparatus of claim 1, wherein the base casing further has an input end linking to a power supply, an switch for activating the power supply, protrusive struts located therein for fastening to the face panel and an output end linking to the gun.

3. The optical curing apparatus of claim 1, wherein the first face panel has one side attached to a bracket.

4. The optical curing apparatus of claim 1, wherein the gun has at least a lamp set and an air fan located therein.

5. The optical curing apparatus of claim 1, wherein the fiber tube is selectively an uniform tube or tapered with a narrower front end, and is engageable with a colored and transparent protection shield.

6. An optical curing apparatus for solidifying dental resin filling in a tooth to allow the dental resin embedded in the tooth firmly without loosening off for preventing the tooth from repeatedly decaying having electric circuits located therein, the electric circuits comprising:
a main control unit located on a main control circuit including at least a microprocessor, a push button set, a display circuit and an optical test circuit, the main control unit displaying light projection power and detecting time adjustment for light projection power;
a test unit located on a test circuit board including a plurality of light emitting elements and a sensor element, the sensor element sensing light illumination and generates a signal which is processed by the optical test circuit and the microprocessor for displaying and adjusting light illumination; and
an optical control unit housed in the gun substantially including a sensor element, an air fan, a push button and a lamp set;
wherein the electric circuits control output of optical power and light projecting time, and test if the optical power being not sufficient and to extend light projecting time or replace the lamp set.

7. The optical curing apparatus of claim 6 further having a power supply unit.

8. The optical curing apparatus of claim 6, wherein the microprocessor of the main control unit is to receive signals transmitted from various circuits and to output driving signals to various circuits.

9. The optical curing apparatus of claim 6, wherein the push button set of the main control unit includes a plurality of push buttons for outputting activation signals and adjusting control signals of output power, and transmitting the signals to the microprocessor.

10. The optical curing apparatus of claim 6, wherein the display circuit includes a plurality of light emitting elements for receiving output signals delivered from the microprocessor to indicate activation and output power status.

11. The optical curing apparatus of claim 6, wherein the main control unit further has a driving circuit which has an output element including selectively a buzzer or a speaker, the driving circuit being activated by the microprocessor to trigger the output element to generate audio signals to notify users about light projecting time control.

12. The optical curing apparatus of claim 6, wherein the optical test circuit of the main control unit includes a voltage amplifier and a filter for receiving testing optical signals output by the test unit.

13. The optical curing apparatus of claim 6, wherein the main control unit further includes a temperature test circuit which has a voltage amplifier and a filter to receive temperature signals detected by the sensor element located in the optical control unit.

14. The optical curing apparatus of claim 6, wherein the sensor element of the optical control unit detects overheat of the lamp set and transmits a signal to a temperature test circuit and the microprocessor for processing and to activate immediately the air fan to perform heat dispersion operation.
